(19) United States
(12) Patent Application Publication
(10) Pub. No.: US 2006/0273138 A1
(43) Pub. Date: Dec. 7, 2006

(54) Soldering apparatus for printed circuit board, soldering method for printed circuit board and soldering cream printing unit for soldering printed circuit board

(75) Inventors: Seung-hoon Lee, Suwon-si (KR); Suk-young Kang, Suwon-si (KR); Il-jin Kim, Pyeongtaek-si (KR); Jun-chul Shin, Suwon-si (KR); Sang-kyoon Yoon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/445,203

(22) Filed: Jun. 2, 2006

(30) Foreign Application Priority Data
Jun. 7, 2005 (KR) 2005-0048379
Apr. 20, 2006 (KR) 2006-0035712

(51) Int. Cl. A47J 36/02

(52) U.S. Cl. 228/101

(57) ABSTRACT

Provided is a soldering apparatus for a printed circuit board (PCB) for soldering the PCB and one or more electronic components populated on the PCB, the PCB having an upper side and a bottom side that is opposite the upper side, including a PCB INVERTING UNIT for rotatably supporting the PCB; a soldering cream PRINTING UNIT for printing on the lower side of the PCB a soldering cream substantially on a plurality of lead holes formed in the PCB in an inverted state, wherein in the inverted state a position of the PCB is inverted by the PCB INVERTING UNIT such that the lower side of the PCB faces in an upward direction; and a hardener for hardening the printed soldering cream while the one or more electronic components are inserted into the lead holes in a reverted state, wherein in the reverted state a position of the PCB is reverted by the PCB inverter such that the upper side of the PCB faces in a upward direction. Thus, provided is a soldering apparatus for a PCB, a soldering method for the PCB, and a soldering cream PRINTING UNIT for soldering on the PCB electronic components that are soldered on the PCB in high density and more reliability.

### CROSS-REFERENCE TO RELATED APPLICATIONS

This application claims the benefit under 35 U.S.C. §119(a) of Korean Patent Applications No. 2005-0048379, filed on Jun. 7, 2005 and No. 2006-0035712, filed on Apr. 20, 2006, in the Korean Intellectual Property Office, the entire disclosures of which are hereby incorporated by reference.

### BACKGROUND OF THE INVENTION

1. Field of the Invention

The present invention relates to a soldering apparatus for a printed circuit board (PCB), a soldering method for the PCB and a soldering cream PRINTING UNIT for soldering the PCB. More particularly, the present invention relates to a soldering apparatus for a PCB, a soldering method for the same and a soldering cream PRINTING UNIT for soldering the PCB which improves a process and a structure for soldering electronic components onto the PCB.

2. Description of the Related Art

In general, a printed circuit board (PCB) or substrate is used to form a circuit that is electrically connected by using a dry film photoresister and the like after a thin metal plate, such as copper, aluminum or the like, is adhered to a substrate composed of a polyimide, polyester, polyetherimide film or the like. In such PCBs, both land parts for mounting surface mounting device (SMD) components and lead holes for inserting leads of lead components are formed.

A conventional method of soldering electronic components, such as SMD components and lead components onto a conventional PCB is disclosed in Korean Patent Application No. 10-1997-49144, the entire disclosure of which is hereby incorporated by reference. In the conventional method of soldering electronic components, a soldering cream is printed onto land parts provided on the PCB by a screen printing method. Next, the SMD components are positioned using automated equipment to be located in accordance with the printed soldering cream. Then, the soldering cream is hardened by a reflowing method. Afterward, the lead components are inserted into the lead holes provided in the PCB. The lead components are then soldered in the PCB by a wave soldering method in which the PCB contacts with a continuously flowing soldering cream for soldering the lead components inserted into the PCB.

However, in case of the conventional PCB soldering method, if a user uses the wave soldering method, a user can not populate the PCB with a high density of electronic components. This is because the plurality of leads inserted into the lead holes are not sufficiently spaced apart so as to avoid being soldered with each other. Further, there is a need for a more reliable soldering method than the wave soldering method.

Accordingly, there is a need for an improved PCB soldering apparatus, soldering method and soldering cream PRINTING UNIT that allows for a high density of electronic components and increases reliability.

### SUMMARY OF THE INVENTION

An aspect of the present invention is to address at least the above problems and/or disadvantages and to provide at least the advantages described below. Accordingly, an aspect of the present invention is to provide a soldering apparatus for a PCB, a soldering method for the PCB, and a soldering cream PRINTING UNIT for soldering the PCB that the electronic components are soldered on so as to allow for a high density of electronic components and increased reliability.

Additional features of the invention will be set forth in the description which follows, and in part will be apparent from the description, or may be learned by practice of the invention.

The foregoing and/or other aspects of the present invention can be achieved by providing a soldering apparatus for a printed circuit board (PCB) for soldering the PCB and one or more electronic components populated on the PCB, the PCB having an upper side and a bottom side that is opposite the upper side, comprising a PCB INVERTING UNIT for rotatably supporting the PCB; a soldering cream PRINTING UNIT for printing on the lower side of the PCB a soldering cream substantially on a plurality of lead holes formed in the PCB in an inverted state, wherein in the inverted state a position of the PCB is inverted by the PCB INVERTING UNIT such that the lower side of the PCB faces in an upward direction; and a hardener for hardening the printed soldering cream while the one or more electronic components are inserted into the lead holes in a reverted state, wherein in the reverted state a position of the PCB is reverted by the PCB inverter such that the upper side of the PCB faces in a upward direction.

According to an aspect of the present invention, the soldering cream PRINTING UNIT comprises a soldering cream accommodator for accommodating the soldering cream, and a plurality of releasing parts provided in the soldering cream accommodator corresponding to the plurality of the lead holes.

According to an aspect of the present invention, the soldering cream PRINTING UNIT further comprises a pressurizer for pressurizing the soldering cream accommodated in the soldering cream accommodator to be released from the releasing parts.

According to an aspect of the present invention, the PCB INVERTING UNIT comprises a PCB supporter for supporting an edge of the PCB, and a rotation driver for rotating the supporter so as to place the PCB in inverted or reverted state.

According to an aspect of the present invention, the one or more electronic components comprises one or more SMD components populated on the upper side of the PCB and one or more lead components each having a plurality of leads for insertion into the lead holes provided in the PCB, and the one or more SMD components are soldered on the PCB before the one or more lead components are populated on the PCB.

The, foregoing and/or another aspects of the present invention can be achieved by providing a soldering method for a PCB for soldering the PCB and one or more electronic components populated on the PCB, the PCB having an upper side and a lower side that is opposite the upper side, comprising inverting a position of the PCB such that a bottom side of the PCB faces in an upward direction; printing a soldering cream on the bottom side of the PCB substantially on one or more lead holes provided in the PCB; reverting a position of the PCB such that an upper side of the PCB faces in an upward direction; inserting one or more leads provided with the one or more electronic components into the one or more lead holes on the upper side of the PCB; and hardening the soldering cream.

According to an aspect of the present invention, the one or more electronic components comprise one or more SMD components coupled via one or more land parts provided on the upper side of the PCB, and one or more lead components having one or more leads for insertion into the one or more lead holes provided in the PCB.

According to an aspect of the present invention, the soldering method for the PCB further comprises printing the soldering cream on the one or more land parts of the PCB; arranging the one or more SMD components onto the soldering cream printed on the one or more land parts; and hardening the printed soldering cream on the one or more land parts of the PCB.

According to an aspect of the present invention, the soldering method for the PCB further comprises soldering the one or more SMD components onto the one or more land parts provided on the PCB before the one or more lead components are arranged on the PCB.

According to an aspect of the present invention, the soldering method for the PCB further comprises soldering the one or more SMD components onto the one or more land parts provided on the PCB before the one or more lead components are arranged on the PCB.

According to an aspect of the present invention, the soldering method for the PCB further comprises printing the soldering cream on the one or more land parts of the PCB; arranging the one or more SMD components onto the soldering cream printed on the one or more land parts; and hardening the printed soldering cream on the one or more land parts.

The foregoing and/or another aspects of the present invention can be achieved by providing soldering apparatus for a PCB for soldering the PCB and one or more electronic components disposed on the PCB, comprising a first conveyer for conveying the PCB in which the one or more electronic components are installed thereon; a first INVERTING UNIT for inverting a bottom side of the PCB conveyed from the first conveyer to face in an upward direction; a second conveyer for conveying the inverted PCB by the first INVERTING UNIT; a soldering cream PRINTING UNIT for printing a soldering cream on a plurality of lead holes of the PCB supported on the second conveyer; a second INVERTING UNIT for reverting an upper side of the PCB conveyed from the second conveyer to face in a downward direction; and a hardener for hardening the soldering cream in a state that the electronic component is inserted into one or more lead holes of the PCB conveyed from the second INVERTING UNIT.

According to an aspect of the present invention, the soldering cream PRINTING UNIT comprises a soldering cream accommodator which is disposed adjacent to the second conveyer and accommodates the soldering cream, and a mask plate in which a plurality of releasing parts are perforated and formed therein to release the soldering cream corresponding to the one or more lead holes of the inverted PCB.

According to an aspect of the present invention, the soldering cream PRINTING UNIT further comprises a pressurizer for pressurizing the soldering cream to release the soldering cream accommodated in the soldering cream accommodator from the releasing parts.

According to an aspect of the present invention, the pressurizer is provided in a pair disposed opposite to each other and having a predetermined inclined angle with a plate surface of the mask plate so that the pressurizer pressurizes the soldering cream to release the soldering cream from the releasing parts when the pressurizer moves along the plate surface of the mask plate.

According to an aspect of the present invention, the pressurizer comprises an elastic member provided with an end part of the pressurizer to elastically pressurize the soldering cream along the plate surface of the mask plate.

According to an aspect of the present inventions each releasing part comprises: a first releasing part comprising a first releasing hole which is formed to have a predetermined depth from an upper plate surface of the mask plate; and a second releasing part comprising a second releasing hole which is connected with the first releasing hole and is perforated to a bottom plate surface of the mask plate having a cross section smaller than that of the first releasing hole.

According to an aspect of the present invention, a bottom end side of the second releasing part is formed to be spaced apart from the one or more lead holes of the PCB with a predetermined interval in a soldering cream printing position in which the mask plate and the PCB are connected therebetween and then the soldering cream is printed on the one or more lead holes of the PCB.

According to an aspect of the present invention, the second releasing part comprises a predetermined inclined surface concaved from the bottom plate surface of the mask plate to form a predetermined angle with the bottom plate surface of the mask plate on the bottom side.

According to an aspect of the present invention, the hardener comprises a heater for heating a lower region of the PCB in a process of conveying the PCB; and an exhaust part which is provided in a predetermined region and guides generated high temperature air from the heater that does not contact an upper region of the PCB and then exhausts the generated air.

The foregoing and/or another aspects of the present invention can be achieved by providing a soldering cream PRINTING UNIT for a PCB to solder the PCB and one or more electronic components disposed on the PCB, comprising a soldering cream accommodator for accommodating the soldering cream; and a mask plate in which a plurality of releasing parts are perforated and formed to release the soldering cream that corresponds to one or more lead holes of the PCB.

According to an aspect of the present invention, the soldering cream PRINTING UNIT for a PCB further comprises a pressurizer for pressurizing the soldering cream to release the soldering cream accommodated in the soldering cream accommodator from the releasing parts.

According to an aspect of the present invention, he pressurizer is provided in a pair disposed opposite to each other and having a predetermined inclined angle with a plate surface of the mask plate so that the pressurizer pressurizes the soldering cream to release the soldering cream from the releasing parts when the pressurizer moves along the plate surface of the mask plate.

According to an aspect of the present invention, the pressurizer further comprises an elastic member connected with an end part of the pressurizer to elastically pressurize the soldering cream along the plate surface of the mask plate.

According to an aspect of the present invention, each releasing part comprises one or more first releasing parts each comprising a first releasing hole which is formed to have a predetermined depth from an upper plate surface of the mask plate; and one or more second releasing parts each comprising a second releasing hole which is connected with the first releasing hole and is perforated to a bottom plate surface of the mask plate and having a cross section smaller than that of the one or more first releasing holes.

According to an aspect of the present invention, a bottom end side of the one or more second releasing parts is formed to be spaced apart from the one or more lead holes of the PCB with a predetermined distance in a soldering cream printing position in which the mask plate and the PCB are in contact and then the soldering cream is printed on the one or more lead holes of the PCB.

According to an aspect of the present invention, the one or more second releasing part comprises a predetermined inclined surface concaved from the bottom plate surface of the mask plate to form a predetermined angle with the bottom plate surface of the mask plate on the bottom side.

The foregoing and/or another aspects of the present invention can be achieved by providing a soldering method for a PCB to solder the PCB with one or more electronic components disposed on the PCB, comprising conveying the PCB on which the one or more electronic components are installed thereon by a first conveyer; inverting a bottom side of the PCB conveyed from the first conveyer to face toward an upward direction by a first INVERTING UNIT; conveying the inverted PCB in the first INVERTING UNIT by a second conveyer; printing the soldering cream on a plurality of lead holes of the PCB supported on the second conveyer by a soldering cream PRINTING UNIT; reverting an upper side of the PCB conveyed from the second conveyer to face a downward direction by a second INVERTING UNIT; inserting one or more leads of the one or more electric components into the plurality of lead holes provided on the upper side of the PCB; and hardening the soldering cream.

According to an aspect of the present invention, the one or more electronic components comprise one or more surface mounting device (SMD) components installed with one or more land parts provided on the upper side of the PCB and one or more lead components having one or more leads to insert into the plurality of lead holes of the PCB, and the method further comprises soldering the one or more SMD component on the one or more land parts of the PCB before the one or more lead components are installed on the PCB.

According to an aspect of the present invention, the soldering method for the PCB further comprises printing the soldering cream on the one or more land parts of the PCB to install the one or more SMD components on the PCB before the one or more lead components are installed on the PCB; arranging the one or more SMD components on the soldering cream printed on the one or more land parts of the PCB; and hardening the soldering cream printed on the one or more land parts of the PCB.

According to an aspect of the present invention, the soldering cream PRINTING UNIT comprises a soldering cream accommodator which is disposed adjacent to the second conveyer and accommodates the soldering cream, and a mask plate in which a plurality of releasing parts are perforated and formed therein to release the soldering cream corresponding to the one or more lead holes of the inverted PCB.

According to an aspect of the present invention, the soldering cream PRINTING UNIT further comprises a pressurizer for pressurizing the soldering cream to release the soldering cream accommodated in the soldering cream accommodator from the releasing parts.

According to an aspect of the present invention, the hardening comprises heating a lower region of the PCB in a process of conveying the PCB; and exhausting in which an exhaust part provided in a predetermined region guides the generated high temperature air from the heater that does not contact an upper region of the PCB and then exhausts the generated air.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic view of a SMD component soldering process of a soldering apparatus according to a first exemplary embodiment of the present invention;

FIG. 2 is a schematic view of a lead component soldering process of the soldering apparatus according to the first exemplary embodiment of the present invention;

FIG. 3 is a sectional view of a PCB INVERTING UNIT of FIG. 2;

FIG. 4 is a perspective view of a soldering cream PRINTING UNIT of FIG. 2;

FIG. 5 is a flow chart of a soldering method according to the first exemplary embodiment of the present invention;

FIG. 6 is a schematic view of a soldering process of the soldering apparatus according to a second exemplary embodiment of the present invention;

FIG. 7 is an exploded perspective view of the principal part of a soldering cream PRINTING UNIT according to the second exemplary embodiment of the present invention;

FIG. 8 is a sectional view taken along VIII-VIII of FIG. 7;

FIG. 9 is a magnified partial sectional view of the sectional view of FIG. 8;

FIG. 10 is a sectional view of a soldering cream pressurizing process;

FIG. 11 is a sectional view taken along X-X of FIG. 6;

FIG. 12 is a schematic view of an operation process of the soldering apparatus of FIG. 6;

FIG. 13 is a flow chart of the soldering method of the soldering apparatus of FIG. 6.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

### First Embodiment

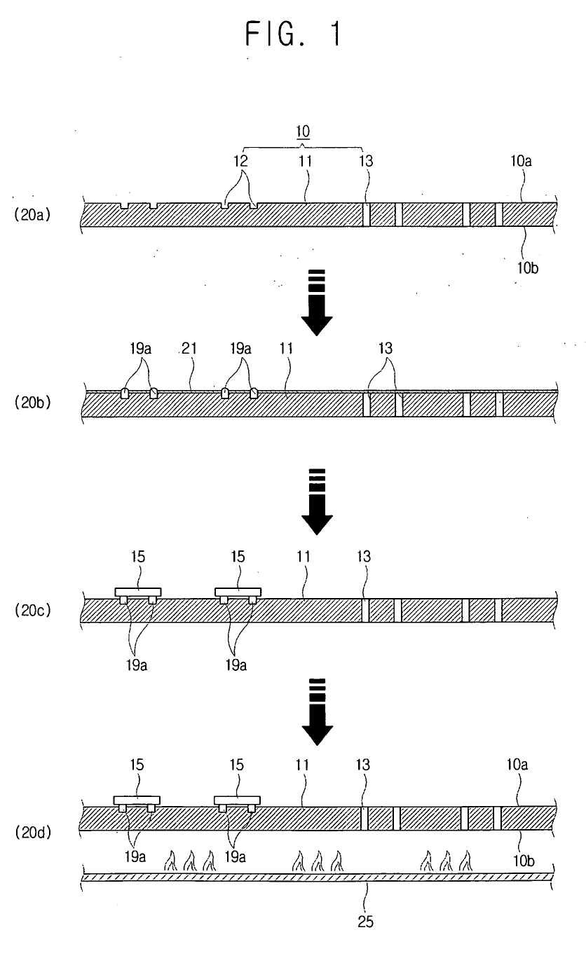

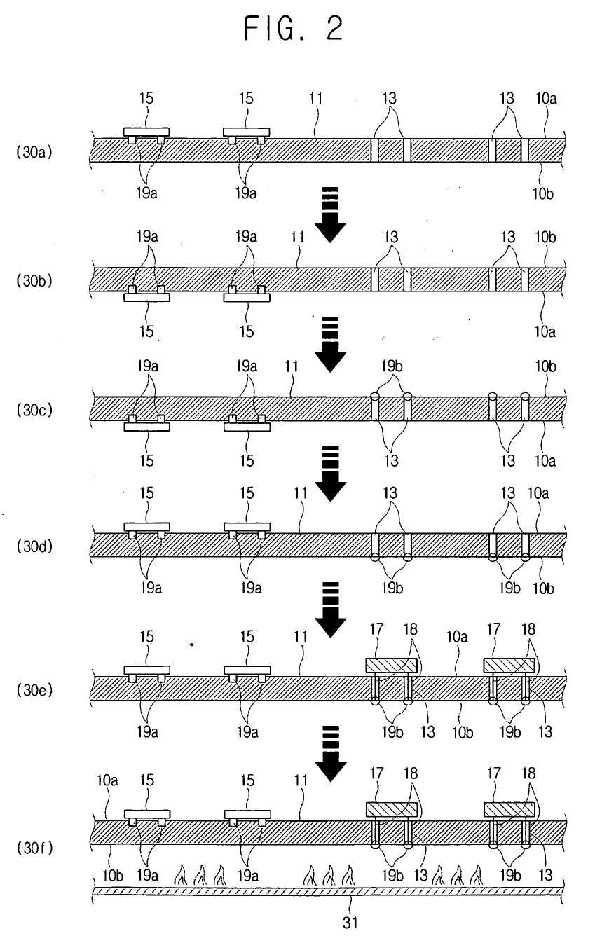

As shown in FIGS. 1 and 2, a soldering apparatus for a PCB according to a first exemplary embodiment of the present invention solders a PCB 10 with electronic components 15 and 17 disposed thereon. Soldering processes based on the soldering apparatus comprise a SMD component soldering process (refer to FIG. 1) and a lead component soldering process (refer to FIG. 2). In the SMD component soldering process, SMD components are positioned onto land parts 12 of the PCB 10 and then soldered. In the lead component soldering process, leads 18 of the lead components 17 are positioned into lead holes 13 of the PCB 10 and then soldered. In the lead component soldering process PCB 10 may already comprise soldered SMD components 15.

The PCB 10 comprises a substrate 11 shaped like a plate, land parts 12 that are formed concavely on the substrate 11 for the installation of the SMD components 15, and lead holes 13 penetrated through the substrate 11 for the installation of the lead components 17 (refer to FIG. 1).

The substrate 11 is provided in the shape of thin plate and is composed of polyimide, polyester, polyetherimide film or the like. The land parts 12 are depressions in an upper side 10a of the substrate 11 for accommodating a soldering cream 19a. The land parts 12 are electrically connected to the SMD components 15 by the soldering cream 19a. The lead holes 13 penetrate through the substrate 11 for accommodating the leads 18 provided with the lead components 17 and for accommodating soldering cream 19. Accordingly, leads 18 are electrically connected with a surface electrical signal path of the substrate 11 by soldering cream 19b. The soldering cream 19a and 19b is provided as a liquid paste type soldering cream for soldering the electronic components 15 and 17, such as SMD components 15 and lead components 17, and may be of various different viscosities and be comprised of various different types of raw materials. For convenience, the soldering cream 19a is shown for soldering the SMD components 15 and the soldering cream 19b is shown for soldering the lead components 17.

As shown in FIG. 1, the SMD component soldering process comprises a PCB loading procedure 20a in which the PCB 10 is loaded to begin the SMD component soldering process, a screen printing procedure 20b in which the soldering cream 19a is printed on the land parts 12 of the loaded PCB 10, an SMD component installation procedure 20c in which the SMD components 15 are positioned onto the printed soldering cream 19a, and a hardening procedure 20d for hardening the soldering cream 19a for the SMD components 15.

In the PCB loading procedure 20a, the PCB 10, in which land parts 12 and lead holes 13 on the substrate 11 are provided, is transported from a cassette (not shown) to the SMD component soldering process.

In the screen printing procedure 20b, the soldering cream 19a is printed on the land parts 12 of the loaded PCB 10 by a screen printing method after a mask 21 is combined with the PCB 10. Thereby the soldering cream 19a is printed on the land parts 12 of the loaded PCB 10.

In the SMD component installation procedure 20c, the plurality of SMD components 15 are positioned onto the printed soldering cream 19 by using automated equipment such as a robotic arm (not shown).

In the hardening procedure 20d, the soldering cream 19a is melted and then hardened. For the hardening procedure 20d, the soldering cream 19 is melted using hardener 25 and the hardening for the SMD components occurs after a reflowing method. Accordingly, there is no contact degradation between the SMD components 15 and the soldering cream 19a as a result of the SMD component installation procedure 20c.

Through the SMD component soldering process, the soldering apparatus for the PCB 10 according to the first exemplary embodiment of the present invention can solder the SMD components 15 onto the PCB 10.

As shown in FIG. 2, the lead component soldering process comprises a PCB loading procedure 30a in which the PCB 10 installed with the SMD components 15 in the SMD components soldering process is loaded to begin the lead component soldering process, a PCB inverting procedure 30b inverting PCB 10 such that the position of an upper side 10a and bottom side 10b are reversed, a soldering cream printing procedure 30c in which the soldering cream 19b is printed in the lead holes 13 of the inverted PCB 10, a PCB reverting procedure 30d reverting the PCB 10 such that the position of the upper side 10a and bottom side 10b of the PCB 10 in which the soldering cream 19b is printed thereon are restored, a lead component installation procedure 30e inserting the leads 18 of the lead components 17 into the lead holes 13 of the PCB 10, and a hardening procedure 30f for hardening the soldering cream 19b.

In the PCB loading procedure 30a, the PCB 10 is transported from the cassette (not shown) to the lead component soldering process. PCB loading procedure 30a is similar to PCB loading procedure 20a.

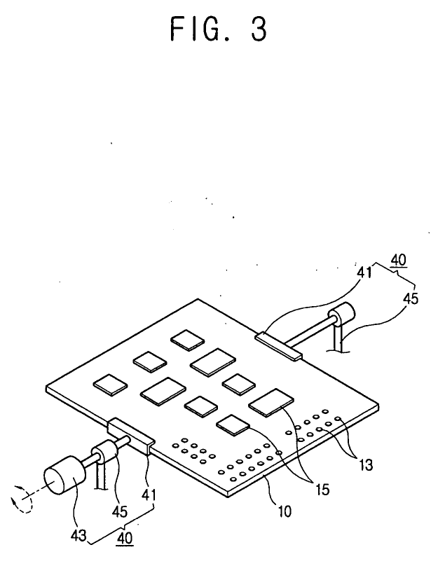

In the PCB inverting procedure 30b, the PCB 10 is rotated 180 degrees by using the PCB INVERTING UNIT 40 shown in FIG. 3 so that a bottom side 10b and the upper side 10a of the PCB 10 are reversed in position.

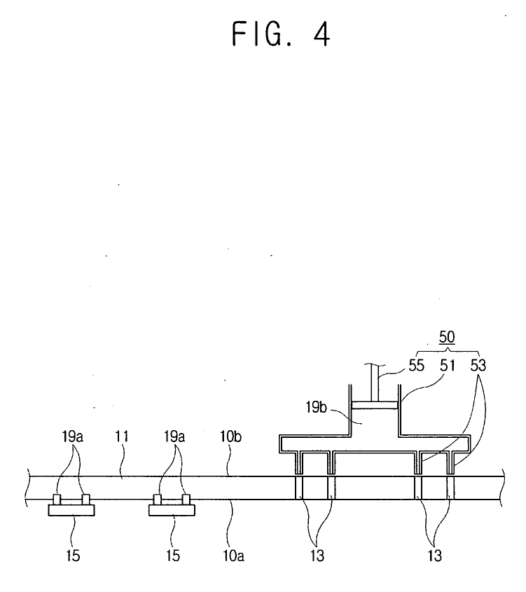

In the soldering cream printing procedure 30c, the soldering cream 19b is printed in the lead holes 13 provided on the bottom side 10b of the PCB 10 by a soldering cream PRINTING UNIT 50 shown in FIG. 4.

In the PCB reverting procedure 30d, the PCB 10 is rotated 180 degrees by the PCB INVERTING UNIT 40 so that the upper side 10a and bottom side 10b of the PCB 10 are reversed in position.

In the lead component installing procedure 30e, the leads 18 of the plurality of lead components 17 are inserted into the lead holes 13 provided in the upper side 10a of the PCB 10. The lead component installation procedure 30e may be accomplished manually. Alternatively, automated equipment, such as a robotic arm (not shown), may be used for the lead component installation procedure 30e.

In the hardening procedure 30f, the soldering cream 19b is melted and then hardened. For the hardening procedure 30f, the soldering cream 19b is melted using hardener 31 and the hardening occurs after a reflowing method is used. Accordingly, the contacts between the lead components 17 and the soldering cream 19b are not degraded as a result of the lead component installation procedure 30e.

Accordingly, the soldering apparatus for the PCB according to the first exemplary embodiment of the present invention can solder the lead components 17 onto the PCB 10 through the lead component soldering process.

As shown in FIG. 3, the PCB INVERTING UNIT 40 comprises PCB supporter 41 for supporting an edge of the PCB 10, and a rotating driver 43 for providing driving power for rotating the PCB supporter 41 to invert and revert the position of the PCB 10. The PCB INVERTING UNIT 40 may further comprise supporter 45 for supporting the PCB supporter 41.

The PCB supporter 41 is provided in a pair to support opposite edges of the PCB 10. However, the PCB supporter 41 may be singly provided to support one edge of the PCB 10. Likewise, supporter 45 is provided in a pair to support each PCB supporter 41. However, the supporter 41 may be singly provided to support one PCB supporter 41.

The rotating driver 43 is coupled with the PCB supporter 41, and rotates the PCB supporter 41 to rotate between an inverted position in which the upper side 10a of the PCB 10 faces the downward direction and a reverted position in which the upper side 10a of the PCB 10 faces the upward direction. The rotating driver 43 may comprise a driving motor (not shown) for providing the driving power to rotate the PCB supporter 41.

As shown in FIG. 4, the soldering cream PRINTING UNIT 50 comprises a soldering cream accommodator 51 accommodating the soldering cream 19b, and a plurality of releasing parts 53 provided with the soldering cream accommodator 51 and corresponding to the plurality of lead holes 13. The soldering cream PRINTING UNIT 50 may further comprise a pressurizer 55 for pressurizing the soldering cream 19b accommodated in the soldering cream accommodator 51 to release the soldering cream 19b through the releasing parts 53.

The pressurizer 55 is provided in the shape of a piston and is moveable by a predetermined amount by a driver (not shown). The pressurizer 55 causes the soldering cream 19b to be released through the releasing parts 53 by pressing the soldering cream 19b accommodated in the soldering cream accommodator 51. Accordingly, a predetermined amount of the soldering cream 19b is provided through the releasing parts 53 of the soldering cream PRINTING UNIT 50 to the lead holes 13 provided on the bottom side 10b of the PCB 10.

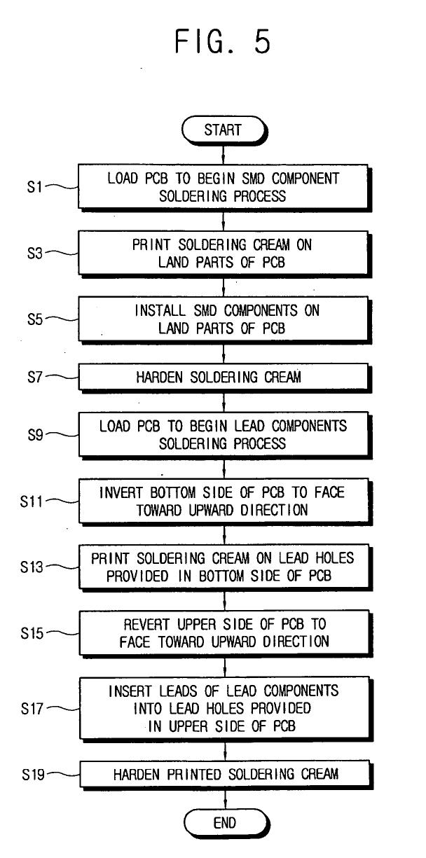

With this configuration, the soldering method for the PCB 10 according to the first exemplary embodiment of the present invention will be described referring to FIG. 5. The soldering method for soldering electronic components installed on the PCB 10, according to the first exemplary embodiment of the present invention, comprises the SMD component soldering procedure for installing SMD components 15 on the PCB 10, and the lead component soldering procedure for installing lead components 17 on the PCB 10 installed with the SMD components 15.

The SMD component soldering process comprises an operation S1 in which the PCB 10 is loaded to begin the SMD component soldering process, an operation S3 in which the soldering cream 19a is printed on the land parts 12 of the PCB 10, an operation S5 in which the SMD components 15 are installed on the soldering cream 19a printed on the land parts 12 of the PCB 10, and an operation S7 in which the printed soldering cream 19a is melted and then hardened to electrically connect the SMD components 15 with the land parts 12.

The lead component soldering process comprises an operation S9 in which the PCB 10 is loaded to begin the lead component soldering process, an operation S11 in which the PCB 10 is inverted so that the bottom side 10b faces toward an upward direction, an operation S13 in which the soldering cream 19b is printed on the lead holes 13 on the bottom side 10b of the PCB 10, an operation S15 in which the PCB 10 is inverted so that the upper side 10a of the PCB 10 faces toward an upward direction, an operation S17 in which the leads 18 of the lead components 17 are inserted into the lead holes 13 on the upper side 10a of the PCB 10, and an operation S19 in which the printed soldering cream 19b is melted and then hardened to electrically connect the lead components 17 with the lead holes 13.

Through these processes, electronic components such as the SMD components 15 and the lead components 17 are reliably soldered.

The soldering apparatus for the PCB 10 comprises the PCB INVERTING UNIT 40 and the soldering cream PRINTING UNIT 50 to supply the predetermined amount of soldering cream 19b through the releasing parts 53 of the soldering cream PRINTING UNIT 50. Accordingly, the soldering apparatus for the PCB 10 prevents the excess soldering cream 19b from spreading to adjacent lead holes 13. Further, the leads 18 provided with the lead components 17 are inserted into the lead holes 13 provided on the upper side 10a of the PCB 10 and are electrically connected to the soldering cream 19b attached to the lead holes 13 provided in the bottom side 10b of the PCB 10. Accordingly, it soldering cream 19b can be prevented from spreading to adjacent lead holes 13 and being electrically connected with the adjacent leads 18. Also, a high density of electronic components can be soldered on the PCB 10.

### Second Embodiment

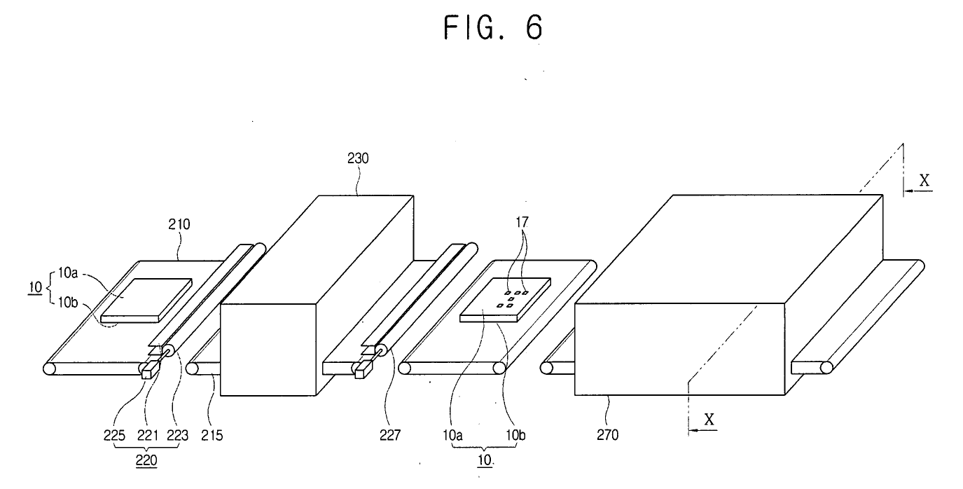

As shown in FIGS. 6 through 11, a soldering apparatus for a PCB according to a second exemplary embodiment of the present invention comprises a first conveyer 210 for conveying a PCB 10 that already has SMD components 15 installed thereon. Also included is a first INVERTING UNIT 220 for inverting the bottom side 10b of the PCB 10 conveyed from the first conveyer 210 to face in an upward direction. A second conveyer 215 is included for conveying the PCB 10 inverted by the first INVERTING UNIT 220. Further included is a soldering cream PRINTING UNIT 230 for printing a soldering cream 19b on a plurality of lead holes 13 of the PCB 10 supported on the second conveyer 215. Additionally, a second INVERTING UNIT 227 is included for reverting the upper side 10a of the PCB 10 conveyed from the second conveyer 215 to face in a downward direction. A hardener 270 is included for hardening the soldering cream 19b in a state that the electronic components 17 are inserted into the lead holes 13 of the PCB 10 conveyed by the second INVERTING UNIT 227.

As shown in FIG. 6, the first conveyer 210 conveys the PCB 10 in which the SMD components 15 are already installed. The first conveyer 210 may comprise a plurality of rollers (not shown), a conveyer belt (not shown) supported by the rollers, and a driving motor (not shown) driving at least one of the plurality of rollers.

As shown in FIG. 6, the first INVERTING UNIT 220 inverts the bottom side 10b of the PCB 10 conveyed from the first conveyer 210 to face toward an upward direction. The first INVERTING UNIT 220 comprises a cramp part 221 accommodating the PCB 10 and a rotation driving part 225 for rotating the cramp part 221. The first INVERTING UNIT 220 support the cramp part 221. Also, the first INVERTING UNIT 220 comprises a rotation part 223 connected to the rotation driving part 225. The cramp part 221 is “U” shaped to accommodate an edge of the PCB 10 and to be capable of rotating 180 degrees. The rotation driving part 225 is connected to the rotation part 223. Also, the rotation driving part 225 provides driving power so that the rotation part 223 is rotated between an inversion position in which the upper side 10a of the PCB 10 faces toward a downward direction and a reversion position in which the upper side 10a of the PCB 10 faces toward an upward direction. A driving motor (not shown) for generating driving power may be provided in the rotation driving part 225.

As shown in FIG. 6, the second conveyer 215 conveys the PCB 10 inverted by the first INVERTING UNIT 220. The soldering cream PRINTING UNIT 230 prints the soldering cream 19b on the lead holes 13 of the PCB 10 and is disposed with the second conveyer 215. An explanation about the second conveyer 215 will be omitted since the second conveyer 215 has the same configuration as the first conveyer 210.

As shown in FIGS. 6 through 10, the soldering cream PRINTING UNIT 230 prints the soldering cream 19b on the plurality of lead holes 13 of the PCB 10 supported on the second conveyer 215. The soldering cream PRINTING UNIT 230 comprises a mask plate 231 disposed adjacent to the second conveyer 215. The soldering cream PRINTING UNIT 230 further comprises a pressurizer 261 for pressurizing the soldering cream 19b accommodated in the soldering cream accommodator 233 to be released from the releasing parts 241. The soldering cream PRINTING UNIT 230 may comprise a mask plate positioning means (not shown) for positioning the mask plate 231 toward the PCB 10 that is supported on the second conveyer 215 and a pressurizer positioning means (not shown) for positioning the pressurizer 261.

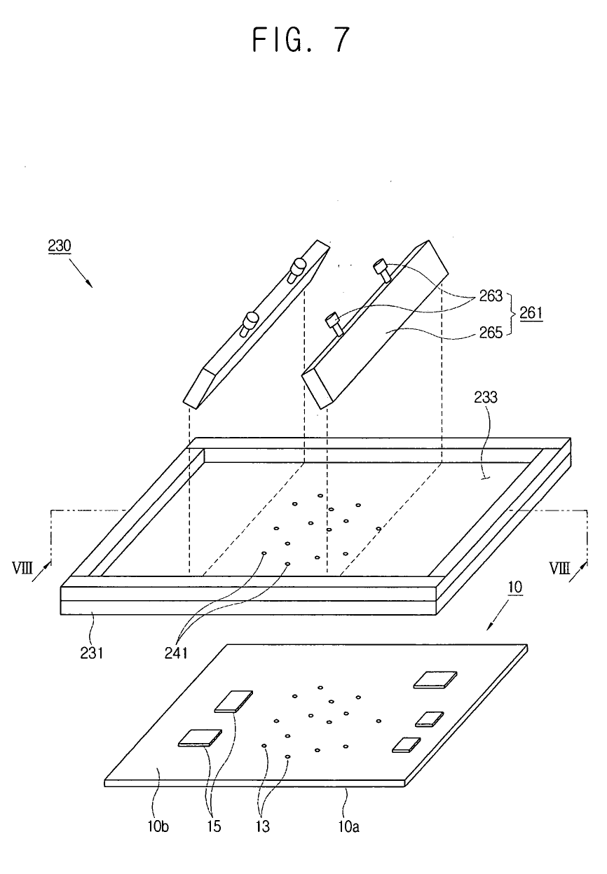

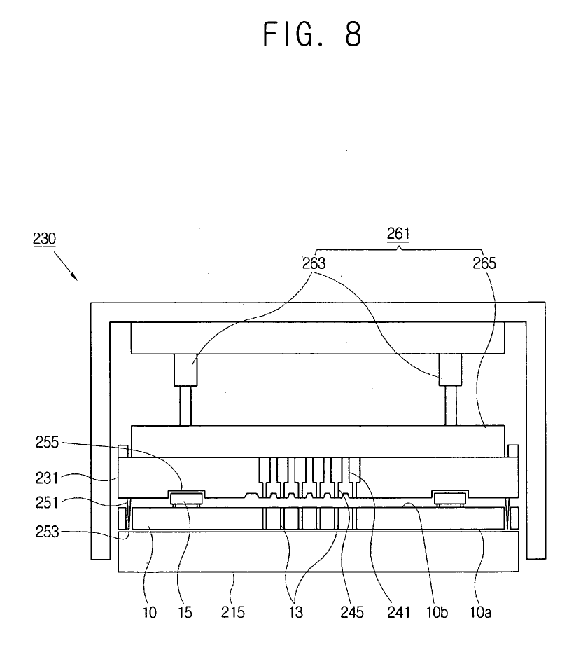

As shown in FIGS. 7 and 8, the mask plate 231 is disposed adjacent to the second conveyer 215. The mask plate 231 comprises the soldering cream accommodator 233 for accommodating the soldering cream 19b. The mask plate 231 further comprises the plurality of releasing parts 241 perforated therethrough for releasing the soldering cream 19b, wherein the plurality of releasing parts 241 correspond to the lead holes 13 of the inverted PCB 10. It is preferred that the mask plate 231 has a rectangular shape. However, the mask plate 231 may have a polygonal or any other shape. It is preferred that the mask plate 231 is made of aluminum which is readily available and has a low price. However, various types of well-known materials can be selectively adopted for mask plate.

A plurality of position fixing protrusions 251 are protruded from an edge in the bottom side of a plate surface of the mask plate 231 in order to maintain a position of the PCB 10 in a printing position of the soldering cream 19b. The position fixing protrusions 251 are engaged with position fixing holes 253 of the PCB 10 so that a relative position of the PCB 10 with respect to the mask plate 231 is maintained in a printing process. Also, the mask plate 231 comprises an electronic component accommodator 255 which is a concaved portion in the bottom plate surface of the mask plate 231. The electronic component accommodator 255 allows for protrusions from the bottom side 10b of the PCB 10, thereby maintaining a constant distance with the lead holes 13 of the PCB 10 and accommodating any installed electronic components 15 and 17.

As shown in FIGS. 7, 9 and 10, the soldering cream accommodator 233 is provided in the upper part of the mask plate 231 and accommodates the soldering cream 19b. In the soldering cream accommodator 233, the soldering cream 19b is accommodated in a space formed by long rods (not shown) combined with the edges of the plate surface of the mask plate 231. The plurality of releasing parts 241 are perforated from the upper plate surface of the mask plate 231 to the bottom plate surface thereof in the soldering cream accommodator 233.

As shown in FIGS. 8 through 10, each of plurality of releasing parts 241 comprises a first releasing hole 243 which has a predetermined depth from the upper plate surface of the mask plate 231, and a second releasing part 245 having a second releasing hole 246 which is connected with the first releasing hole 243 and perforated to the bottom plate surface of the mask plate 231 having a cross section smaller than that of the first releasing hole 243.

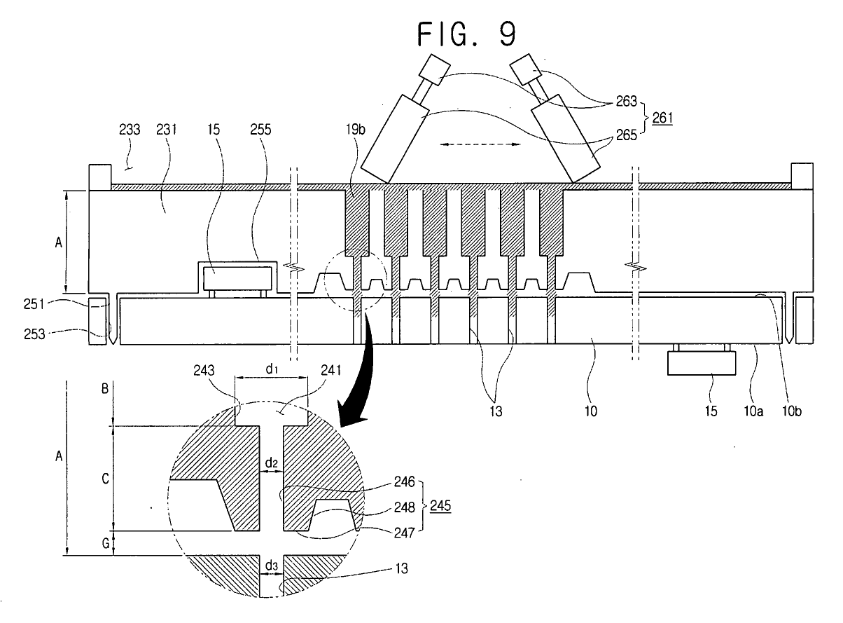

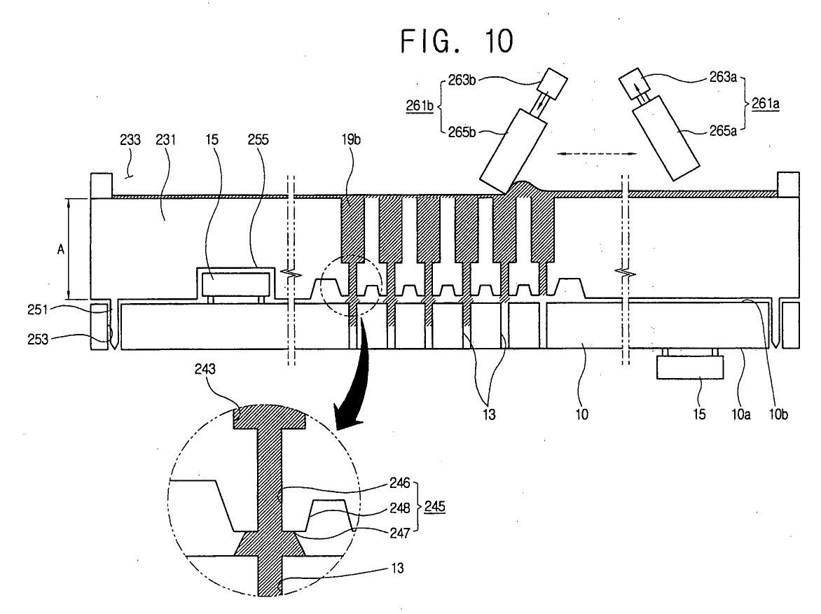

As shown in FIGS. 9 and 10, the first releasing part 241 comprises the first releasing hole 243 which is formed to have the predetermined depth from the upper plate surface of the mask plate 231. The cross section of the first releasing hole 243 of releasing part 241 is lager than that of the second releasing hole 246 of the second releasing part 245. Accordingly, the first releasing hole 243 can accommodate a predetermined amount of the soldering cream 19b thereby allowing the soldering cream 19b to be securely and uniformly provided with the second releasing hole 246 in a process of releasing the soldering cream 19b. It is preferred that the cross section of the first releasing hole 243 of the first releasing part 242 has a circular shape. However, the cross section thereof may comprise various shapes such as a hexagonal or any other shapes.

As shown in FIGS. 9 and 10, the second releasing part 245 comprises the second releasing hole 246 which is connected with the first releasing hole 243 and is perforated to the bottom surface of the mask plate 231. The cross section of the second releasing hole 246 of the second releasing part 245 is smaller than that of the first releasing hole 243.

Accordingly, the soldering cream 19b is securely released from the second releasing hole 246 having a small size that corresponds to the lead holes 13 of the PCB 10.

Also, it is preferred that a bottom side 247 of the second releasing part 245 be spaced apart from the lead holes 13 of the PCB 10 in printing position of the soldering cream 19b. In the printing position of the soldering cream 19b the mask plate 231 and the PCB 10 are brought together and the soldering cream 19b is printed on the lead holes 13 of the PCB 10. The second releasing part 245 comprises an inclined surface 248 that is concaved from the bottom plate surface of the mask plate 231 to form a predetermined angle with the bottom plate surface of the mask plate 231 in the bottom side 247. Accordingly, when the soldering cream 19b is released from the second releasing hole 246, the spreading of the soldering cream 19b between the bottom end side 247 of the second releasing hole 246 and the lead holes 13 of the PCB 10 can be prevented. Then, the soldering cream 19b can be securely and uniformly provided for the lead holes 13 of the PCB 10. The size of the mask plate 231 according to the second exemplary embodiment of the present invention will be described referring the FIG. 9.

Assuming that the plate thickness (referring to “A” shown in FIG. 9) of the mask plate 231 is 6 mm, it is preferred that the depth (referring to “B” shown in FIG. 9) of the first releasing hole 243 from the upper plate surface of the mask plate 231 is 4 mm and the diameter (referring to “D1” shown in FIG. 4) of the first releasing hole 243 is 1.5 mm. It is preferred that the height (referring to “C” shown in FIG. 4) of the second releasing hole 246 is 1.5 mm and the diameter (referring to “D2” shown in FIG. 4) of the second releasing hole 246 is 1 mm. It is preferred that an distance (referring to “G” shown in FIG. 4) between the bottom end side 247 of the second releasing hole 246 and the lead holes 13 of the PCB 10 is 0.5 mm. Each of the above numerical distance values may be modified according to the viscosity of the soldering cream 19b, the size of the lead holes 13 of the PCB 10, the size of the first releasing hole 243, the size of the second releasing hole 246, the thickness of the mask plate 231 and the like.

As shown in FIGS. 7 through 10, the pressurizer 261 is provided on the upper part of the mask plate 231 and pressurizes the soldering cream 19b for releasing the soldering cream 19b accommodated in the soldering cream accommodator 233 from the releasing parts 241. It is preferred that the pressurizer 261 be provided in as a pair that are oppositely disposed in relation to each other so as to have a predetermined inclined angle with the plate surface of the mask plate 231. This arrangement allows the pressurizer 261 to pressurize the soldering cream 19b for release from the releasing parts 241 when the pressurizer 261 moves along the plate surface of the mask plate 231. In other words, as shown in FIG. 9, the distance between the lower parts of pressurizer 261 between both elastic members 265 is large but the distance between the upper parts of pressurizer 261is small. Accordingly, one of the elastic members 265 pressurizes the soldering cream 19b so that a process of releasing the soldering cream 19b toward the PCB 10 can be achieved by each movement process from left to right directions or from right to left directions with respect FIG. 9. Accordingly, the above process is more effective than a process of releasing the soldering cream 19b toward the PCB 10 by making both left and right passes with the pressurizer 261.

Also, the elastic member 265 is connected with an end part of the pressurizer 261 to elastically pressurize the soldering cream 19b along the plate surface of the mask plate 231. In a process of pressurizing the soldering cream 19b toward the releasing parts 241, the elastic member 265 is elastically transformed along the winding to pressurize the soldering cream 19b toward the releasing parts 241 with a constant force. Accordingly, the pressurization force in which the soldering cream 19b is pressurized to the releasing parts 241 is uniform so that the amount of the soldering cream 19b released from the releasing parts 241 can be uniform and stable.

The pressurizer 261 comprises a movement means (not shown) conveying the elastic member 265 in left and right directions. The pressurizer 261 further comprises a pressurization member 263, such as an air cylinder, which lifts the elastic member 265 up and down and then closely contacts it to the plate surface of the mask plate 231 or spaces it apart there from.

Also, the soldering cream 19b may selectively be provided to the soldering cream accommodator 233 automatically by an automated supplier (not shown) supplying a predetermined amount of the soldering cream 19b, manually by an user or the like..

With this configuration, a supplying process in which the soldering cream 19b is supplied with the lead holes 13 of the PCB 10 will be described referring to FIG. 10.

First, the soldering cream 19b is provided to the soldering cream accommodator 233. When the PCB 10 supported by the second conveyer 215 is disposed below the mask plate 231, the soldering cream PRINTING UNIT 230 is descended so that the position fixing protrusions 251 of the mask plate 231 are engaged with the position fixing holes 253 of the PCB 10. The above process may be performed by a controller (not shown) capable of controlling the above process. Also, a supporting means (not shown) capable of supporting the PCB 10 in the lower part of the PCB 10 may be provided. The supporting means maintains the horizontality of the PCB 10 so that a distance between the releasing parts 241 of the mask plate 231 and the lead holes 13 of the PCB 10 may be constantly and uniformly maintained. Afterward, the pressurizer 261 moves from a left to right direction of FIG. 10. A right elastic member 265a of a pair of elastic members 265a and 265b is lifted by the pressurization member 263 to be space apart from the mask plate 231. Also, the right elastic members 265a cannot pressurize the soldering cream 19b toward the releasing parts 241. The left elastic member 265b of the pair of elastic members 265a and 265b is inclined at a predetermined angle with the plate surface of the mask plate 231 and is provided to pressurize the soldering cream 19b along a movement direction. The pressurization member 263 descends the left elastic member 265b to contact with the mask plate 231. The soldering cream 19b is pressurized to the releasing parts 241 according to moving the left elastic members 265b. The pressurized soldering cream 19b is provided to the lead holes 13 of the PCB 10 through the first releasing hole 243 and the second releasing hole 246 in order. Accordingly, the soldering cream 19b is spread over the lead holes 13 of the PCB 10 from left to the right directions according to the movement of the elastic members 265a and 265b in order. When the elastic members 265a and 265b reach the right edge of the soldering cream accommodator 233, the process of releasing the soldering cream 19b is ceased. Then, the mask plate 231 is lifted from the PCB 10 so that the position fixing protrusion 251 of the mask plate 231 is separated from the position fixing hole 253 of the PCB 10. Afterward, when the second conveyer 215 supporting the PCB 10 is operated, the PCB 10 reaches the second INVERTING UNIT 227. The second INVERTING UNIT 227 inverts the upper side 10a of the PCB 10 to face toward an upward direction so that the PCB 10 is reverted. At the same time, when the second conveyer 215 conveys the next PCB 10 to be dispose below the lower part of the mask plate 231, the mask plate 231 descends to engage the position fixing protrusion 251 of the mask plate 231 with the position fixing hole 253 of the PCB 10. Afterward, the pair of elastic members 265a and 265b move from right to left directions. At the same time, the left elastic member 265a is lifted so as not to pressurize the soldering cream 19b and is then spaced apart from the plate surface of the mask plate 231. On the other hand, the right elastic member 265a of the pressurizer 261 is descended to pressurize the soldering cream 19b and then to contact with the plate surface of the mask plate 231 so that a process in which the right elastic member 265b pressurizes the soldering cream 19b toward the releasing parts 241 is repeated. The above process may be automatically controlled by the controller which is not shown in drawings. In the above process, the elastic members 256a and 265b are elastically transformed along the plate surface of the mask plate 231 to uniformly pressurize the soldering cream. Also, the elastic members 256a and 265b can prevent the soldering cream 19b released from the second releasing hole 246 from being spread to adjacent lead holes 13 by the inclined surface 248 and a space between the bottom end side 247 of the second releasing part 245 and the lead holes 13 of the PCB 10. Accordingly, the soldering cream 19b is constantly and uniformly released and the soldering process may be reliably operated.

As shown in FIG. 6, after the soldering cream PRINTING UNIT 230 provides the soldering cream 19b to the lead holes 13 of the PCB 10, the second INVERTING UNIT 227 inverts the upper side 10a of the PCB 10 to face toward an upward direction so that the PCB 10 is reverted. Since the second INVERTING UNIT 227 has the same configuration as compared with the first INVERTING UNIT 220, an explanation of the second INVERTING UNIT 227 is omitted. The soldering apparatus may comprise a controller (not shown) controlling whether or not the rotation driver 225 of the first and the second INVERTING UNITs 220 and 227 are rotated by using a sensor (not shown) for sensing a start and an end of the rotation of the first and the second INVERTING UNITs 220 and 227.

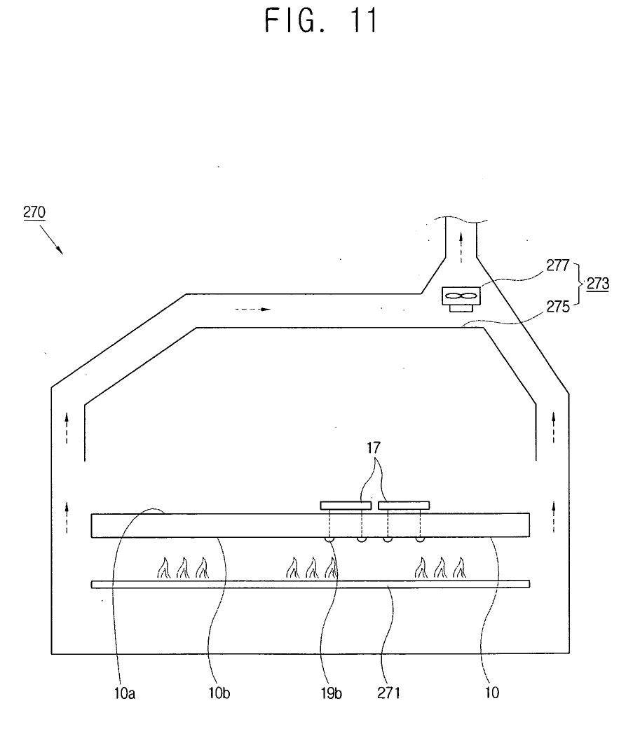

As shown in FIGS. 6 and 11, the hardener 270 hardens the soldering cream 19b by a reflowing method in a state that the electronic components 17 are inserted into the lead holes 13 of the PCB 10 conveyed from the second INVERTING UNIT 227. The hardener 270 comprises a heater 271 heating the lower region of the PCB 10 to electrically connect the soldering cream 19b with the leads 18 of the lead holes 13 in a state of conveying the PCB 10. The hardener 270 further comprises an exhaust part 273 which is provided in a predetermined region and guides the generated high temperature air from the heater 271 that will not contact the upper region of the PCB 10 and exhausts it.

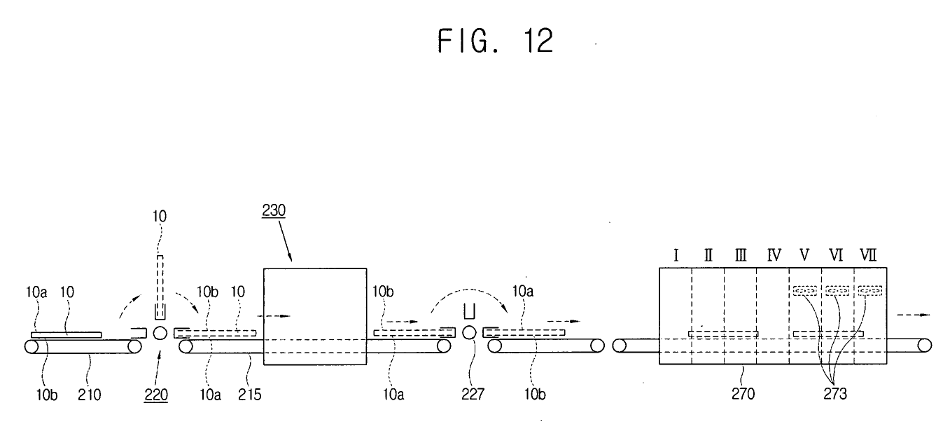

As shown in FIG. 11, the exhaust part 273 is provided in a predetermined region of the hardener 270 that does not contact the high temperature air which is heated near the lower region of the PCB 10 and passed through the inner part of the hardener 270. The exhaust part 273 comprises an exhaust fan 277 which is installed on the upper part in the hardener 270 and exhausts the high-temperature air to the outside. The exhaust part further comprises an exhausting duct 275 guiding the high-temperature air to the exhausting fan 277 that is not to be transferred to the upper part of the PCB 10. Accordingly, the soldered part between the electronic components 15 and 17 provided on the upper region of the PCB 10 and the substrate 11 can be prevented from melting from the high-temperature air. It is preferred that the region in which the exhaust part 273 is provided is a portion, referring to “V” through “VII” shown in FIG. 12, in which the PCB 10 is exhausted from the hardener 270 with respect to the movement direction of the PCB 10 in which the temperature of the PCB 10 is slightly increased by heating of the heater 271. The exhaust part 273 is provided in consideration of the number of the electronic components 15 and 17 soldered on the PCB 10, a melting point of the soldering creams 19a and 19b, heating temperature of the heater 171, inner space of the hardener 270 and the like.

The controller which is not shown in drawings can sense whether the PCB 10 reaches from the first and the second conveyers 210 and 215 to the first and the second INVERTING UNITs 220 and 227 or not and control the first and the second INVERTING UNIT 220 and 227 to invert or revert the PCB 10. Also, the controller can control an attachment and detachment process between the soldering cream PRINTING UNIT 230 and the PCB 10, temperature of the heater 271 in the hardener 270 and the like.

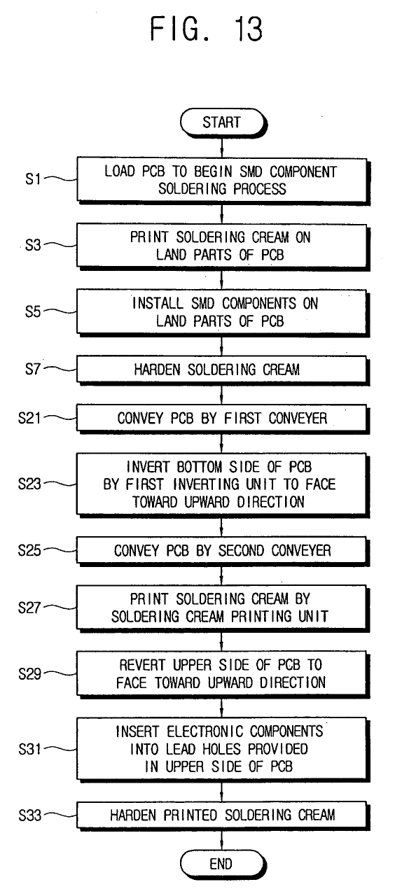

The PCB soldering process having the above configuration according to the second exemplary embodiment of the present invention will be described referring to FIGS. 12 and 13. The SMD component soldering process, referring to “S1” through “S7” shown in FIG. 13, are the same as in the first embodiment and a discussion thereof is omitted.

A lead components soldering process comprises the following operations. An operation S21 in which the first conveyer 210 conveys the PCB 10 in which the SMD components 15 are installed. An operation S23 in which the first INVERTING UNIT 220 inverts the bottom side 10b of the PCB 10 conveyed by the first conveyer 210 to face toward upward an direction. An operation S25 in which the second conveyer 215 conveys the PCB 10 inverted by the first conveyer 210. An operation S27 in which the soldering cream PRINTING UNIT 230 prints the soldering cream 19b on the plurality of lead holes 13 of the PCB 10 supported on the second conveyer 215. An operation S29 in which the second INVERTING UNIT 227 reverts the upper side 10a of the PCB 10 conveyed by the second conveyer 215 to face toward the upward direction. An operation S31 in which the leads 18 of the lead components 17 are inserted into the lead holes 13 provided in the upper side 10a of the PCB 10. An operation S33 in which the harder 270 hardens the printed soldering cream 19b by the reflowing method. Through these above processes, the electronic components 15 and 17 such as the SMD components 15 and the lead components 17 can be reliably soldered.

According to the second exemplary embodiment of the present invention, the soldering cream can be constantly and uniformly provided to the lead holes of the PCB so that confidence of the soldering process can be increased. Also, a flow of high temperature air is regulated so that the soldering quality of the soldered electronic components can be enhanced in the hardening process of the soldering cream.

In the exemplary embodiments of the present invention, the lead component soldering process can be performed to install lead components 17 in the PCB 10 that is already populated with SMD components 15, after the SMD component soldering process which is performed to install the SMD components 15 on the PCB 10. However, the SMD component soldering process can be performed after the lead component soldering process.

The exemplary embodiments of the present invention provides for a soldering apparatus for a PCB, a soldering method for the PCB, and a soldering cream PRINTING UNIT for soldering on the PCB electronic components that are soldered on the PCB in high density and more reliability.

While the invention has been shown and described with reference to certain embodiments thereof, it will be understood by those skilled in the art that various changes in form and details may be made therein without departing from the spirit and scope of the invention as defined by the appended claims.

What is claimed is:

1. A soldering apparatus for a printed circuit board (PCB) for soldering the PCB and one or more electronic components populated on the PCB, the PCB having an upper side and a bottom side that is opposite the upper side, comprising:
a PCB INVERTING UNIT for rotatably supporting the PCB;
a soldering cream PRINTING UNIT for printing on the lower side of the PCB a soldering cream substantially on a plurality of lead holes formed in the PCB in an inverted state, wherein in the inverted state a position of the PCB is inverted by the PCB INVERTING UNIT such that the lower side of the PCB faces in an upward direction; and
a hardener for hardening the printed soldering cream while the one or more electronic components are inserted into the lead holes in a reverted state, wherein in the reverted state a position of the PCB is reverted by the PCB inverter such that the upper side of the PCB faces in a upward direction.

2. The soldering apparatus for the PCB according to claim 1, wherein the soldering cream PRINTING UNIT comprises a soldering cream accommodator for accommodating the soldering cream, and a plurality of releasing parts provided in the soldering cream accommodator corresponding to the plurality of the lead holes.

3. The soldering apparatus for the PCB according to claim 2, wherein the soldering cream PRINTING UNIT further comprises a pressurizer for pressurizing the soldering cream accommodated in the soldering cream accommodator to be released from the releasing parts.

4. The soldering apparatus for the PCB according to claim 1, wherein the PCB INVERTING UNIT comprises a PCB supporter for supporting an edge of the PCB, and a rotation driver for rotating the supporter so as to place the PCB in inverted or reverted state.

5. The soldering apparatus for the PCB according to claim 1, wherein the one or more electronic components comprises one or more SMD components populated on the upper side of the PCB and one or more lead components each having a plurality of leads for insertion into the lead holes provided in the PCB, and
the one or more SMD components are soldered on the PCB before the one or more lead components are populated on the PCB.

6. A soldering method for a PCB for soldering the PCB and one or more electronic components populated on the PCB, the PCB having an upper side and a lower side that is opposite the upper side, comprising:
inverting a position of the PCB such that a bottom side of the PCB faces in an upward direction;
printing a soldering cream on the bottom side of the PCB substantially on one or more lead holes provided in the PCB;
reverting a position of the PCB such that an upper side of the PCB faces in an upward direction;
inserting one or more leads provided with the one or more electronic components into the one or more lead holes on the upper side of the PCB; and
hardening the soldering cream.

7. The soldering method for the PCB according to claim 6, wherein the one or more electronic components comprise one or more SMD components coupled via one or more land parts provided on the upper side of the PCB, and one or more lead components having one or more leads for insertion into the one or more lead holes provided in the PCB.

8. The soldering method for the PCB according to claim 7, further comprising:
printing the soldering cream on the one or more land parts of the PCB;
arranging the one or more SMD components onto the soldering cream printed on the one or more land parts; and
hardening the printed soldering cream on the one or more land parts of the PCB.

9. The soldering method for the PCB according to claim 8, further comprising soldering the one or more SMD components onto the one or more land parts provided on the PCB before the one or more lead components are arranged on the PCB.

10. The soldering method for the PCB according to claim 7, further comprising soldering the one or more SMD components onto the one or more land parts provided on the PCB before the one or more lead components are arranged on the PCB.

11. The soldering method for the PCB according to claim 10, further comprising:
printing the soldering cream on the one or more land parts of the PCB;
arranging the one or more SMD components onto the soldering cream printed on the one or more land parts; and
hardening the printed soldering cream on the one or more land parts.

12. A soldering apparatus for a PCB for soldering the PCB and one or more electronic components disposed on the PCB, comprising:
a first conveyer for conveying the PCB in which the one or more electronic components are installed thereon;
a first INVERTING UNIT for inverting a bottom side of the PCB conveyed from the first conveyer to face in an upward direction;
a second conveyer for conveying the inverted PCB by the first INVERTING UNIT;
a soldering cream PRINTING UNIT for printing a soldering cream on a plurality of lead holes of the PCB supported on the second conveyer;
a second INVERTING UNIT for reverting an upper side of the PCB conveyed from the second conveyer to face in a downward direction; and
a hardener for hardening the soldering cream in a state that the electronic component is inserted into one or more lead holes of the PCB conveyed from the second INVERTING UNIT.

13. The soldering apparatus for the PCB according to claim 12, wherein the soldering cream PRINTING UNIT comprises a soldering cream accommodator which is disposed adjacent to the second conveyer and accommodates the soldering cream, and a mask plate in which a plurality of releasing parts are perforated and formed therein to release the soldering cream corresponding to the one or more lead holes of the inverted PCB.

14. The soldering apparatus for the PCB according to claim 13, wherein the soldering cream PRINTING UNIT further comprises a pressurizer for pressurizing the soldering cream to release the soldering cream accommodated in the soldering cream accommodator from the releasing parts.

15. The soldering apparatus for the PCB according to claim 14, wherein the pressurizer is provided in a pair disposed opposite to each other and having a predetermined inclined angle with a plate surface of the mask plate so that the pressurizer pressurizes the soldering cream to release the soldering cream from the releasing parts when the pressurizer moves along the plate surface of the mask plate.

16. The soldering apparatus for the PCB according to claim 15, wherein the pressurizer comprises an elastic member provided with an end part of the pressurizer to elastically pressurize the soldering cream along the plate surface of the mask plate.

17. The soldering apparatus for the PCB according to claim 14, wherein each releasing part comprises:
a first releasing part comprising a first releasing hole which is formed to have a predetermined depth from an upper plate surface of the mask plate; and
a second releasing part comprising a second releasing hole which is connected with the first releasing hole and is perforated to a bottom plate surface of the mask plate having a cross section smaller than that of the first releasing hole.

18. The soldering apparatus for the PCB according to claim 17, wherein a bottom end side of the second releasing part is formed to be spaced apart from the one or more lead holes of the PCB with a predetermined interval in a soldering cream printing position in which the mask plate and the PCB are connected therebetween and then the soldering cream is printed on the one or more lead holes of the PCB.

19. The soldering apparatus for the PCB according to claim 18, wherein the second releasing part comprises a predetermined inclined surface concaved from the bottom plate surface of the mask plate to form a predetermined angle with the bottom plate surface of the mask plate on the bottom side.

20. The soldering apparatus for the PCB according to claim 12, wherein the hardener comprises:
a heater for heating a lower region of the PCB in a process of conveying the PCB; and
an exhaust part which is provided in a predetermined region and guides generated high temperature air from the heater that does not contact an upper region of the PCB and then exhausts the generated air.

21. A soldering cream PRINTING UNIT for a PCB to solder the PCB and one or more electronic components disposed on the PCB, comprising:
a soldering cream accommodator for accommodating the soldering cream; and
a mask plate in which a plurality of releasing parts are perforated and formed to release the soldering cream that corresponds to one or more lead holes of the PCB.

22. The soldering cream PRINTING UNIT for a PCB according to claim 21, further comprising a pressurizer for pressurizing the soldering cream to release the soldering cream accommodated in the soldering cream accommodator from the releasing parts.

23. The soldering cream PRINTING UNIT for a PCB according to claim 22, wherein the pressurizer is provided in a pair disposed opposite to each other and having a predetermined inclined angle with a plate surface of the mask plate so that the pressurizer pressurizes the soldering cream to release the soldering cream from the releasing parts when the pressurizer moves along the plate surface of the mask plate.

24. The soldering cream PRINTING UNIT for a PCB according to claim 23, wherein the pressurizer further comprises an elastic member connected with an end part of the pressurizer to elastically pressurize the soldering cream along the plate surface of the mask plate.

25. The soldering cream PRINTING UNIT for a PCB according to claim 24, wherein each releasing part comprises:
one or more first releasing parts each comprising a first releasing hole which is formed to have a predetermined depth from an upper plate surface of the mask plate; and
one or more second releasing parts each comprising a second releasing hole which is connected with the first releasing hole and is perforated to a bottom plate surface of the mask plate and having a cross section smaller than that of the one or more first releasing holes.

26. The soldering cream PRINTING UNIT for a PCB according to claim 25, wherein a bottom end side of the one or more second releasing parts is formed to be spaced apart from the one or more lead holes of the PCB with a predetermined distance in a soldering cream printing position in which the mask plate and the PCB are in contact and then the soldering cream is printed on the one or more lead holes of the PCB.

27. The soldering cream PRINTING UNIT for a PCB according to claim 26, wherein the one or more second releasing part comprises a predetermined inclined surface concaved from the bottom plate surface of the mask plate to form a predetermined angle with the bottom plate surface of the mask plate on the bottom side.

28. A soldering method for a PCB to solder the PCB with one or more electronic components disposed on the PCB, comprising:
conveying the PCB on which the one or more electronic components are installed thereon by a first conveyer;
inverting a bottom side of the PCB conveyed from the first conveyer to face toward an upward direction by a first INVERTING UNIT;
conveying the inverted PCB in the first INVERTING UNIT by a second conveyer;
printing the soldering cream on a plurality of lead holes of the PCB supported on the second conveyer by a soldering cream PRINTING UNIT;
reverting an upper side of the PCB conveyed from the second conveyer to face a downward direction by a second INVERTING UNIT;
inserting one or more leads of the one or more electric components into the plurality of lead holes provided on the upper side of the PCB; and
hardening the soldering cream.

29. The soldering method for the PCB according to claim 28, wherein the one or more electronic components comprise one or more surface mounting device (SMD) components installed with one or more land parts provided on the upper side of the PCB and one or more lead components having one or more leads to insert into the plurality of lead holes of the PCB, and
the method further comprises soldering the one or more SMD component on the one or more land parts of the PCB before the one or more lead components are installed on the PCB.

30. The soldering method for the PCB according to claim 26, further comprising:
printing the soldering cream on the one or more land parts of the PCB to install the one or more SMD components on the PCB before the one or more lead components are installed on the PCB;
arranging the one or more SMD components on the soldering cream printed on the one or more land parts of the PCB; and
hardening the soldering cream printed on the one or more land parts of the PCB.

31. The soldering method for the PCB according to claim 28, wherein the soldering cream PRINTING UNIT comprises a soldering cream accommodator which is disposed adjacent to the second conveyer and accommodates the soldering cream, and a mask plate in which a plurality of releasing parts are perforated and formed therein to release the soldering cream corresponding to the one or more lead holes of the inverted PCB.

32. The soldering method for the PCB according to claim 28, wherein the soldering cream PRINTING UNIT further comprises a pressurizer for pressurizing the soldering cream to release the soldering cream accommodated in the soldering cream accommodator from the releasing parts.

33. The soldering method for the PCB according to claim 28, wherein the hardening comprises:
heating a lower region of the PCB in a process of conveying the PCB; and
exhausting in which an exhaust part provided in a predetermined region guides the generated high temperature air from the heater that does not contact an upper region of the PCB and then exhausts the generated air.
